(19) United States
(12) Patent Application Publication
(10) Pub. No.: US 2005/0088268 A1
(43) Pub. Date: Apr. 28, 2005

(54) Silicon steel structure

(76) Inventor: Shih H. Chen, Taoyuan City (TW)

Correspondence Address: Yi-Wen Tseng, 509 ROOSEVELT BLVD. #D306, FALL CHURCH, VA, 22044, US

(21) Appl. No.: 10/693,027

(22) Filed: Oct. 27, 2003

(51) Int. Cl. H01F 27/29

(52) U.S. Cl. 336/192

(57) ABSTRACT

An improved silicon steel structure is disclosed, which has an interior ring, an exterior ring concentrically arranged with the interior ring, a plurality of radially extending support bridges interconnecting an exterior edge of the interior ring and an interior edge of the exterior ring, and a magnet absorbing surface attached to an exterior edge of the exterior ring. The exterior ring further includes a pair of semi-circular rings.

### BACKGROUND OF THE INVENTION

The present invention relates to an improved silicon steel structure, and more particularly, to a coil set with a silicon steel applied to a heat dissipating fan. The coil set is fabricated with a simple process and a low cost. Further, the coil of the coil set does not affect the magnetic force generated by the coil set.

As shown in FIG. 1, the conventional heat dissipating fan 100a comprises an enclosure 10a, a base 20a, a blade wheel 30a and a plurality of coils 40a. The blade wheel 30a includes a bearing 301a, in which a shaft 302a is installed, a magnet 303a disposed along an inner edge of the shaft 302a, and a plurality of blades 304a formed along an exterior side of the shaft bearing 301a. Referring to FIG. 2, the coil 40a fits over the sleeve 201a of the base 20a. The coil 40a includes a plurality of silicon steel sheets 1a stacked over each other. The stack of silicon steel is winded with a coil 3a. The side surface of the stack of silicon steel forms a magnetic absorbing surface A.

Referring to FIG. 1, the coil set 40a fits over the bearing cap 201a of the base 20a first. The shafts 302 of the blade wheel 30a is then inserted into the bearing cap 201a, such that the coil set 40a is encased by blade wheel 30a. The side surface of the stack of silicon steel 1a forms a magnetic surface A faces the magnet 303a. Thereby, a heat dissipating fan 100a is assembled. During operation, electricity is conducted, and magnetic interaction is generated between the magnetic absorbing surface A and the magnet 303a to drive the blade wheel 30a for rotation.

However, the above heat dissipating fan has the following drawbacks.

1. A plurality of silicon steel stacks 1a is stacked over each other for forming the magnetic absorbing surface A. This is inconvenient for assembly and costly.

2. While winding the coil 3a around the stack of silicon steel 1a, the top and bottom sides of the coil 3a are exposed. Therefore, when the magnetic absorbing surface A is interacting with the magnet 303a, the exposed portion of the coil 3a is also interacted to reduce the magnetic absorbing effect and torque generated thereby. The rotation force and speed for the blade wheel are thus affected.

### BRIEF SUMMARY OF THE INVENTION

The present invention provides an improved silicon steel structure to provide a more convenient assembly process; and thereby, the assembly time and cost can be effectively reduced.

The present invention further provides an improved silicon steel structure of which the magnetic absorbing surface of the silicon steel is not affected by the coil winded thereabout.

The improved silicon steel structure provided by the present invention comprises an interior ring, an exterior ring concentrically arranged with the interior ring, a plurality of radially extending support bridges interconnecting an exterior edge of the interior ring and an interior edge of the exterior ring, and a magnet absorbing surface attached to an exterior edge of the exterior ring. The exterior ring further comprises a pair of semi-circular rings.

The present invention further provides an improved silicon steel structure comprising a first silicon steel sheet and a second silicon steel sheet stacked with each other. Each of the first and second silicon steel sheet comprises an inner ring, an outer ring arranged concentrically with the inner ring, a plurality of support bridges interconnecting the inner ring and the outer ring, and a magnetic absorbing surface attached to an exterior edge of the outer ring.

The present invention further provides set of coil, comprising a first silicon steel sheet and a second silicon steel sheet stacked with other and a plurality of coils. Each of the first and second silicon steel sheets comprises an inner ring, an outer ring arranged concentrically with the inner ring, a plurality of support bridges interconnecting the inner ring and the outer ring, and a magnetic absorbing surface attached to an exterior edge of the outer ring. The coils wind around the support bridges with a vertical height no larger than the height of the magnetic absorbing surface.

The present invention further provides a heat dissipating fan, comprising a blade wheel, a magnet mounted along an interior periphery of the blade wheel, and a plurality of coil sets. Each of the coil sets comprises a stack of silicon steel sheet, comprising a plurality of radially extending arms between a center and a periphery thereof, a magnetic absorbing surface attached to a periphery of the stack and facing the magnet, and a plurality of coils winding around the support bridges. The fan of further comprises a plurality of blades extending radially from an exterior periphery of the blade wheel, and a shaft extending along a central axe of the blade wheel.

### BRIEF DESCRIPTION OF THE DRAWINGS

These, as well as other features of the present invention, will become apparent upon reference to the drawings wherein:

FIG. 1 shows a cross-sectional view of a conventional heat dissipating fan;

FIG. 2 shows a perspective view of a conventional coil set

FIG. 3 shows a cross-sectional view of a heat dissipating fan provided by the present invention;

FIG. 4 shows two dissembled silicon steel sheets;

FIG. 5 shows the assembly of the silicon steel sheets;

FIG. 6 shows a cross-sectional view of the assembly of the silicon steel sheets;

FIG. 7 shows a perspective view of two silicon steel sheets winded with a coil;

FIG. 8 shows the cross-sectional view of the silicon steel sheets winded with the coil; and

FIG. 9 shows another embodiment of an assembly of silicon steel.

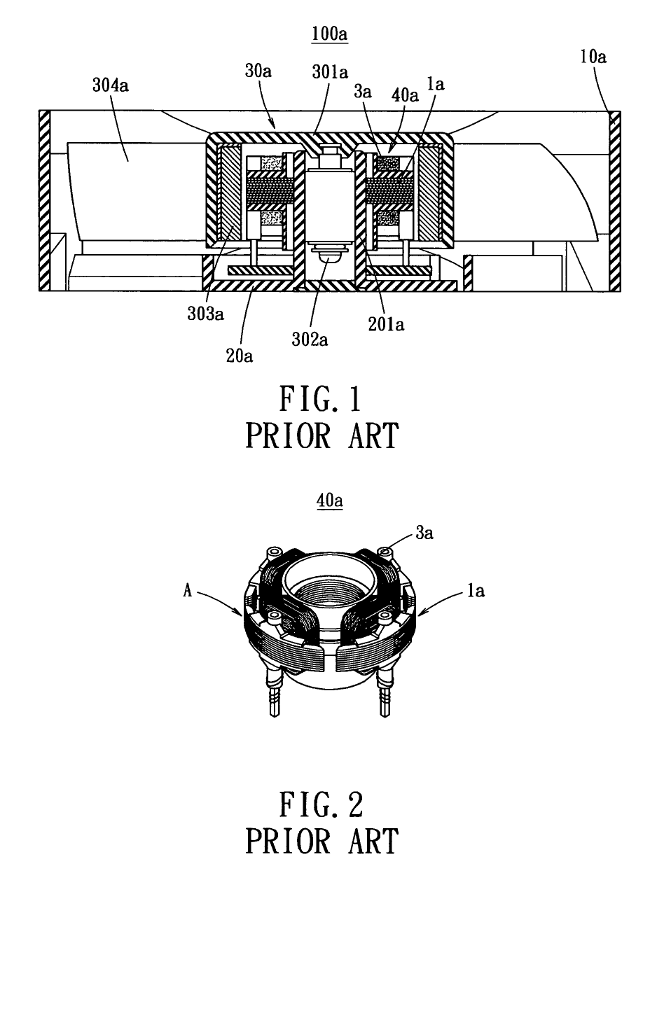

### DETAILED DESCRIPTION OF THE INVENTION

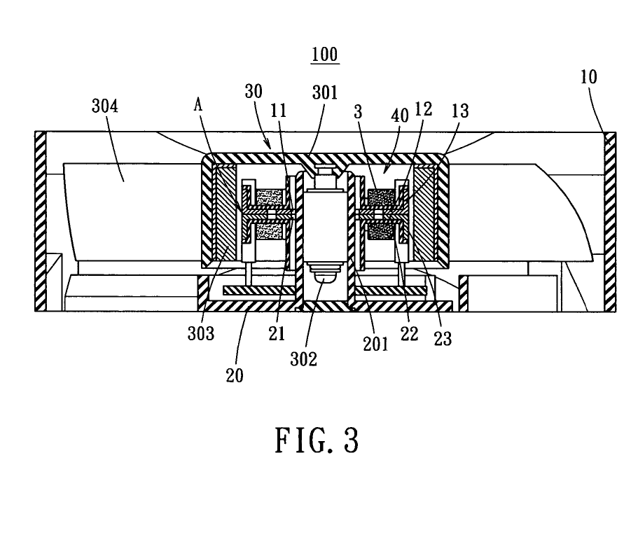

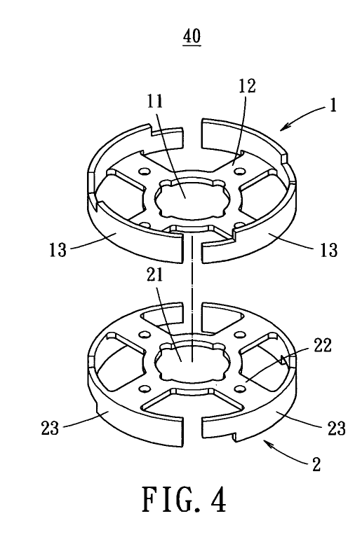

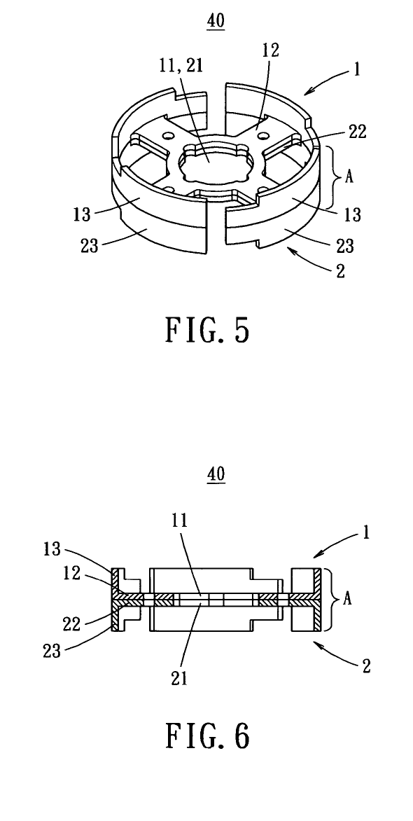

As shown in FIGS. 3 and 4, the silicon steel sheets 1 and 2 provided by the present invention are applied to a coil set 40 of a heat dissipating fan 100. The heat dissipating fan 100 comprises a housing 10, a base 20, a blade wheel 30 and a plurality of coil sets 40. The blade wheel 30 includes a bearing 301, in which a shaft 302 is mounted. A magnet 303 is installed along an interior edge of the bearing 301, and a plurality of blades 304 are attached to an exterior side of the bearing 301. The base 20 includes a shaft cap 201 protruding from a center thereof. The coil sets 40 fit over the cap 201 and encased by the blade wheel 30. The coil sets 40 are level with the magnet 303.

As shown in FIG. 4, each coil set 40 includes at least two silicon steel sheets 1 and 2 stacked with each other. The silicon steel sheets 1 and 2 each comprise two semi-circular exterior rings and an interior ring. The silicon steel sheets 1 and 2 further comprises a plurality of support bridges 12 and 22 extending radially inwardly from the inner surfaces of the exterior rings towards the interior ring to connected to each other by a plurality of supporting bridges 12 and 22. The interior rings constructs central channel 12, 21 of the silicon steel sheets 1 and 2, respectively, for fitting over the cap 201. Exterior surfaces 13 and 23 are attached to the exterior rings to serve as the magnet absorbing surfaces A. The exterior surfaces 13 and 23 have predetermined height defined according to the required torque for rotating the blade wheel 30.

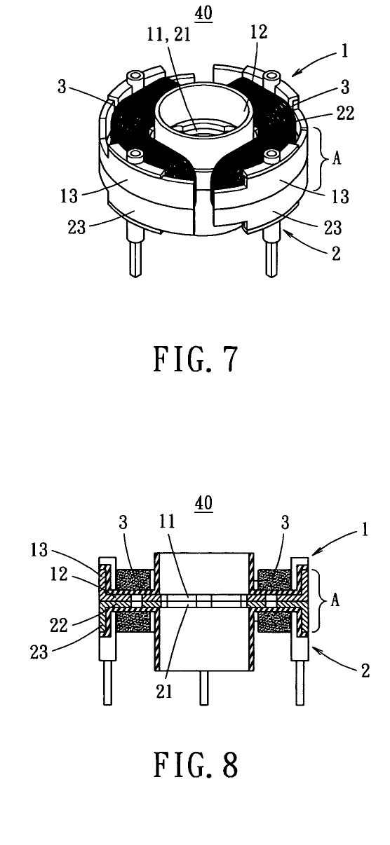

As shown in FIGS. 7-8, coils 3 are winding around the support bridges 12 and 22 with a total thickness smaller than the height of the height of the magnet absorbing surface A. Therefore, the problem caused by exposed coils in the prior art is resolved.

Referring to FIG. 3, the coil sets 40 are installed in the blade wheel 30 between the cap 201 and the magnet 303. When electricity is conducted, an interaction between the magnet absorbing surface A and the magnet 303 is generated to drive the blade wheel 30 to rotate.

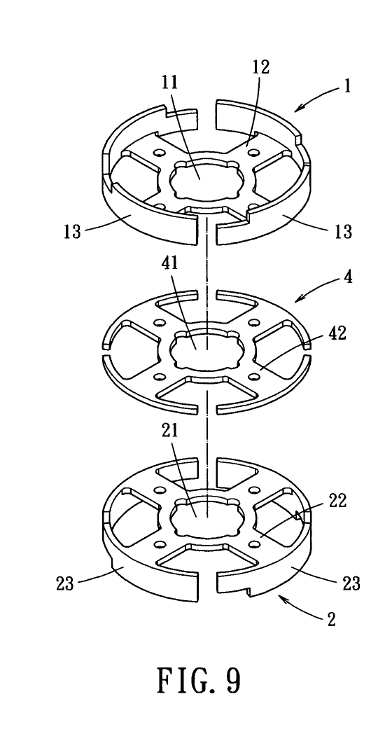

FIG. 9 shows another embodiment of the present invention, in which an additional silicon steel sheet 4 is inserted between stacked silicon steel sheet 1 and 2. Similar to the silicon steel sheets 1 and 2, the silicon steel sheet 4 includes an interior ring, two semi-circular exterior rings concentrically arranged with the interior ring, and a plurality of radially extending support bridges for interconnecting the interior ring and exterior rings. The insertion of the silicon steel sheet 4 increases the overall height of the magnetic absorbing surface A, so that the vertical thickness of coils 3 can be increased.

Accordingly, the present invention provides the following advantages.

1. The coil 3 can easily be applied to the silicon steel sheets 1 and 2 easily only by stacking the silicon steel sheets 1 and 2 together.

2. The overall height of the coil 3 does not exceed the height of the absorbing surface A. In other word, the coil set 40 does not have any exposed coil 3, such that when the magnet surface A is absorbing magnetic energy, the torque generated thereby is not affected, and an improved heat dissipation effect can be achieved.

According to the above, the present invention uses the concept of driven array antenna to generate half-wave antenna members spaced from each other by slots to increase bandwidth of frequency domain. The simple structure successfully establishes an omni-directional radiation field with improved bandwidth. This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. An improved silicon steel structure, comprising an interior ring, an exterior ring concentrically arranged with the interior ring, a plurality of radially extending support bridges interconnecting an exterior edge of the interior ring and an interior edge of the exterior ring, and a magnet absorbing surface attached to an exterior edge of the exterior ring.

2. The structure of claim 1, wherein the exterior ring further comprises a pair of semi-circular rings.

3. An improved silicon steel structure, comprising a first and a second silicon steel sheets stacked with each other, wherein each of the first and second silicon steel sheet comprises:
an inner ring;
an outer ring arranged concentrically with the inner ring;
a plurality of support bridges interconnecting the inner ring and the outer ring; and
a magnetic absorbing surface attached to an exterior edge of the outer ring.

4. The structure of claim 3, wherein each outer ring further comprises a pair of opposing semi-circular rings.

5. The structure of claim 3, further comprising at least a third silicon sheet inserted between the first and second silicon steel sheets.

6. The structure of claim 5, wherein the third silicon sheet includes an inner ring, an outer ring concentrically arranged with the inner ring, and a plurality of support bridges interconnecting the inner and outer rings.

7. A set of coil, comprising:
a first silicon steel sheet and a second silicon steel sheet stacked with other, wherein each of the first and second silicon steels comprises:
an inner ring;
an outer ring arranged concentrically with the inner ring;
a plurality of support bridges interconnecting the inner ring and the outer ring; and
a magnetic absorbing surface attached to an exterior edge of the outer ring; and
a plurality of coils winding around the support bridges.

8. The set of coil according to claim 7, wherein each of the coils has a vertical thickness smaller than a height of the magnetic absorbing surface.

9. The set of coil according to claim 7, further comprising at least a third silicon sheet inserted between the first and second silicon steel sheets.

10. The set of coil according to claim 9, wherein the third silicon sheet includes an inner ring, an outer ring concentrically arranged with the inner ring, and a plurality of support bridges interconnecting the inner and outer rings.

11. The set of coil according to claim 9, wherein each of the coils has a vertical thickness smaller than a total height of the magnetic absorbing surface and the thickness of the third silicon steel sheet.

12. A heat dissipating fan, comprising:
a blade wheel;
a magnet, mounted along an interior periphery of the blade wheel; and
a plurality of coil sets each further comprises:
a stack of silicon steel sheet, comprising a plurality of radially extending arms between a center and a periphery thereof;
a magnetic absorbing surface attached to a periphery of the stack and facing the magnet; and
a plurality of coils winding around the support bridges.

13. The fan of claim 12, further comprising a plurality of blades extending radially from an exterior periphery of the blade wheel.

14. The fan of claim 13, further comprising a shaft extending along a central axe of the blade wheel.

15. The fan of claim 12, further comprising a shaft extending along a central axe of the blade wheel.

16. The fan of claim 14, further comprising a cap fitting over the shaft.

17. The fan of claim 15, wherein the coil sets are installed between the cap and the magnets.
